(19) United States
(12) Patent Application Publication
(10) Pub. No.: US 2025/0296865 A1
(43) Pub. Date: Sep. 25, 2025

(54) COOLING SYSTEM FOR A GLASS FORMING MACHINE

(71) Applicant: Owens-Brockway Glass Container Inc., Perrysburg, OH (US)

(72) Inventors: Peter Severson, Monclova, OH (US); Charles Obee, Monclova, OH (US); Karl Johnston, Perrysburg, OH (US)

(21) Appl. No.: 19/087,490

(22) Filed: Mar. 22, 2025

Related U.S. Application Data
(60) Provisional application No. 63/569,716, filed on Mar. 25, 2024.

(51) Int. Cl. C03B 9/38; C03B 9/14

(52) U.S. Cl. CPC C03B 9/3816; C03B 9/14

(57) ABSTRACT

A glass forming machine includes a blank mold hanger and a blank mold. The blank mold hanger includes a blank mold hanger half that supports a blank mold half and provides cooling fluid to at least one axial cooling channel defined in the blank mold half. The blank mold hanger half defines at least one cooling fluid outlet, which is in fluidic communication with the at least one axial cooling channel of the blank mold half. The blank mold hanger half additionally includes at least one flow control valve that is remotely controllable and configured to selectively adjust a flow of cooling fluid through the at least one axial cooling channel of the blank mold half. A method of cooling a blank mold is also described.

### TECHNICAL FIELD

This patent application discloses innovations related to glass manufacturing and, more particularly, to managing the temperature in a blank mold of a glass container forming machine.

### BACKGROUND

In the process of forming a glass container, a glass container forming machine is supplied with a discrete portion of molten glass, typically referred to as a “glass gob,” which originates from a glass feeder appended to a downstream end of a forehearth or other structure that provides a source of molten glass. The glass gob is initially received in a blank mold of the forming machine where the gob is pressed or blown into a parison. A parison is a hollow preform or, stated differently, a partially-formed container. Once formed, the parison is inverted and transferred to a blow mold of the forming machine where the parison is blown and outwardly expanded into the final glass container. The glass container is then removed from the blow mold and placed on a deadplate before being pushed onto a conveyor. The glass container forming cycle during which a glass gob is delivered to the blank mold and formed into a parison, transferred to the blow mold and formed into a glass container, and eventually removed from the blow mold is constantly repeated as the forming machine continually produces glass containers. In a typical glass container manufacturing plant, multiple glass container forming machines may be grouped together and are fed with glass gobs out-of-sequence to help improve manufacturing efficiency.

Several portions of a glass container forming machine are cooled to support the overall glass container forming process. The blank mold, for instance, may be cooled by directing a flow of cooling fluid, such as air, through axially extending cooling channels defined in the bodies of opposed mold halves. Such cooling of the blank mold is practiced to help regulate the temperature of the mold as the glass gob is pressed/blown into the parison. In practice, however, cooling the blank mold as well as other portions of the forming machine is complicated. For example, one of the challenges involved in blank mold cooling with axial cooling channels is how to effectively control the quantity of heat transferred to the cooling fluid flowing through the cooling channels so that the blank mold does not become too hot or too cold. The current approach to managing heat removal is by manually adjusting flow restrictors located in close proximity to the operating blank mold. Specifically, operations personnel must make corrective manual adjustments to the flow restrictors to increase or decrease the flow rate of cooling fluid being directed through the blank mold halves every so often based on experience and intuition. This manual approach to blank mold cooling can be laborious and often results in sporadic, imprecise, and/or inconsistent corrections to the temperature of the blank mold, and even the step changes to the flow rate of cooling fluid that are possible with the flow restrictors may be too coarse to find and maintain the desired cooling performance.

Another challenge that impacts blank mold cooling is that the glass gob is usually not thermally homogeneous when received in the blank mold. For example, a glass gob is typically delivered from the glass feeder to its respective glass container forming machine by way of a gob distribution system that includes a guide track comprised of lengthy and widespread series of interconnected scoops, troughs, and deflectors dedicated to the forming machine. While traveling through the guide track, the glass gob tends to cool unevenly since, at any given time, only a portion of the gob is physically contacting and sliding against the guide track. Notably, and depending on what portions of the glass gob contact and slide against the guide track and for how long, one or more portions of the glass gob extending axially along the length of the gob and partially circumferentially around the gob may be cooler, and thus more viscous, than other axially and partially circumferentially extending portions of the gob that experienced less or no sliding physical contact with the guide track. Other process conditions may also contribute to portions of the glass gob being hotter or colder than other portions of the gob. Consequently, when a glass gob is received at the blank mold, the gob typically exhibits an inhomogeneous temperature profile about its perimeter, which, after formation of the glass gob into the glass parison, can result in non-uniform elongation and expansion of the glass parison in the blow mold as the hotter portions of the glass parison will flow more readily than the colder portions.

Due to the non-uniform elongation and expansion of glass in the blow mold, the finished glass container may have a variable wall thickness about its perimeter with the thinner portions of the container generally corresponding to the hotter portions of the glass parison and the thicker portions of the container generally corresponding to the colder portions of the glass parison. Current blank mold cooling techniques that rely on axial cooling channels—which, as mentioned above, involve difficult manual interventions to perform—are not refined and precise enough to compensate for the effects of thermal inhomogeneity of the glass gob and, thus, gob thermal inhomogeneity carries through the container forming process and ultimately presents as variations in glass container thickness. In that regard, the glass gob is designed to include more weight in glass than is theoretically necessary to form the specified glass container. This over inclusion of glass helps ensure that the thinnest portion of the as-formed container still meets or exceeds the requisite minimum glass wall thickness specification even though other portions of the container will contain excess glass. More effective ways to manage cooling of the blank mold are therefore needed.

### SUMMARY

A glass forming machine that is disclosed along with a related method. The glass forming machine includes a blank mold hanger having first and second blank mold hanger halves that carry, respectively, first and second blank mold halves of a blank mold. The blank mold includes a plurality of axial cooling channels through which a flow of cooling fluid is passed to regulate the temperature of the blank mold during operation. At least one, and preferably both, of the first and second blank mold hanger halves includes at least one flow control valve that is remotely controllable and configured to selectively adjust a flow of cooling fluid through at least one of the axial cooling channels of its respective the blank mold half. In this way, the flow control valve(s) can be operated to adjust the flow of cooling fluid through different subsets of cooling channels in different angular sectors of the blank mold to, for example, modify a temperature of one angular sector of the blank mold to be different than a temperature of at least one other angular sector of the blank mold. In a preferred embodiment, the blank mold includes four sectors or quadrants, each of which contains a subset of cooling channels through which the flow of cooling fluid is controlled by a flow control valve that is operated by a system controller.

### BRIEF DESCRIPTION OF THE DRAWINGS

FIG. 1 is a cross-sectional view of a blank mold of a glass container forming machine in which the blank mold is receiving a molten glass gob;

FIG. 2 is the same view of the blank mold of FIG. 1 after receiving the molten glass gob;

FIG. 3 is the same view of the blank mold of FIG. 2 after a plunger is extended into the mold;

FIG. 4 is a side elevation view of a glass parison formed in the blank mold of FIGS. 1-3;

FIG. 5 is a cross-sectional view of a blow mold of the glass container forming machine after the blow mold has closed around the parison of FIG. 4;

FIG. 6 is the same view of the blow mold of FIG. 5 after a glass container has been formed from the parison in the blow mold;

FIG. 7 is an isometric view of an illustrative blank mold;

FIG. 8 is a bottom view of the blank mold of FIG. 7;

FIG. 9 is a top view of a pair of blank mold hanger halves carrying opposed blank mold halves of the blank mold of FIGS. 7-8, in which the blank mold is depicted in an open position;

FIG. 10 is the same view of the mold hanger halves of FIG. 9 with the blank mold depicted in a closed position;

FIG. 11 is a perspective view of an inboard side of one of the blank mold hanger halves of FIGS. 9-10;

FIG. 12 is another perspective view of the inboard side the blank mold hanger half of FIG. 11;

FIG. 13 is a perspective view of an outboard side the blank mold hanger half of FIGS. 11-12;

FIG. 14 is a cutaway cross-sectional view of the blank mold hanger half of FIGS. 11-13 taken along section line 14-14 depicted in FIG. 9;

FIG. 15 is a cutaway cross-sectional view of a plenum of the blank mold hanger half of FIGS. 11-14 with the flow control valves being in different positions in FIGS. 14 and 15; and

FIG. 16 is a schematic of an illustrative cooling system of a glass container forming machine and a cooling system for the forming machine.

### DETAILED DESCRIPTION

A glass container forming machine and an associated cooling system are described along with related methods of use. The cooling system permits the temperature of various sectors of the blank mold of the container forming machine to be more precisely controlled and, additionally, allows for asymmetric temperature control of the blank mold. Asymmetric temperature control—that is, a control capability in which different sectors of the blank mold can be controlled to attain different temperatures—is achieved by managing the flow of a cooling fluid to the different sectors of the blank mold and can be employed to compensate for the inhomogeneous temperature profile of glass gobs received in the blank mold. This type of temperature control can help dictate a more desirable flow of glass within the blow mold in an effort to reduce the glass wall thickness variation in the glass containers formed in the forming machine. The cooling system also permits the flow of cooling fluid through the various sectors of the blank mold to be adjusted remotely such that the temperature of the blank mold can be modified as needed without shutting down the forming machine or requiring manufacturing personnel to make manual cooling fluid flow adjustments on moving equipment.

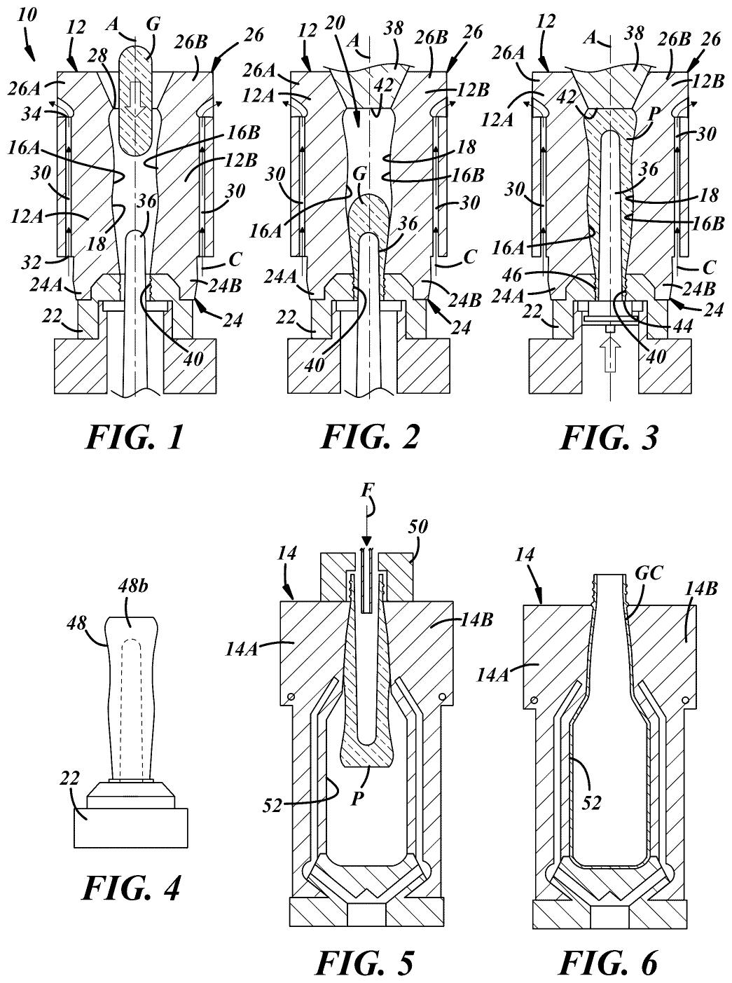

FIGS. 1-6 illustrate part of a glass container manufacturing process employing an illustrative glass forming machine 10 that includes a blank mold 12 and a blow mold 14. The glass forming machine 10 may be part of an I.S. (“individual section”) forming machine that includes a plurality of similar forming machines. While these figures illustrate a press-and-blow process, the present disclosure is equally applicable to a blow-and-blow process or any other type of glass container forming processes that utilize a blank mold 12. Referring now to FIG. 1, the blank mold 12 includes first and second opposed blank mold halves 12A, 12B that are movable towards and away from each other. Each of the blank mold halves 12A, 12B provides an interior molding surface 16A, 16B. When the blank mold halves 12A, 12B are brought together and closed—referred to herein as a “closed position”—the mold halves 12A, 12B make interfacial contact with each other and the opposed interior molding surfaces 16A, 16B provide part of a blank mold cavity surface 18 that delineates a blank mold cavity 20. The blank mold halves 12A, 12B have neck ends 24A, 24B that are closed around a neck ring 22 to provide a neck end 24 of the blank mold 12 and opposed baffle ends 26A, 26B that cooperate to provide a baffle end 26 of the blank mold 12 and establish a gob opening 28 for receipt of a molten glass gob G. When the blank mold halves 12A, 12B are separated and open—referred to herein as a “open position”—the mold halves 12A, 12B are spaced apart from each other and are no longer engaged with the neck ring 22.

The blank mold 12 also defines at least one axial cooling channel 30 defined in each of the blank mold halves 12A, 12B. The axial cooling channel 30 extends axially through its blank mold half 12A, 12B at least partially between the neck and baffle ends 24A, 24B, 26A, 26B of the blank mold half 12A, 12B from an inlet end 32 to an opposed outlet end 34. The inlet end 32 of the axial cooling channel 30 is in fluidic communication with a coolant source (not shown) that provides a flow of cooling fluid C to the cooling channel 30. For each axial cooling channel 30, the flow of cooling fluid C is received into the channel 30 through the inlet end 32 of the channel 30, flows through the channel 30, and exits the channel 30, typically to the surrounding environment, through the outlet end 34 of the channel 30. The flow of cooling fluid C that is directed through the axial cooling channel 30 is preferably comprised of air since ambient air is readily available. However, in other implementations, the cooling fluid flow F supplied to the axial cooling channel 30 may comprise a fluid other than air.

At the beginning of the container forming process, and as shown in FIG. 1, the blank mold halves 12A, 12B are brought together into the closed position and are engaged with the neck ring 22, which itself is comprised of two parts that can be opened and closed. A portion of the neck ring 22 is exposed within the blank mold 12. A glass gob G is then received into the blank mold 12 through the gob opening 28. In the press-and-blow process illustrated here, the end of a plunger 36 partially extends through the neck ring 22 and into the blank mold cavity 20 from the neck end 24 of the mold 12, and the received glass gob G falls onto the plunger 36. After the glass gob G is received in the blank mold 12, a baffle 38 closes off the gob opening 28 at the baffle end 26 of the blank mold 12, as shown in FIG. 2. The blank mold cavity 20 as defined by the blank mold cavity surface 18, which is comprised of a surface 40 of the neck ring 22, a surface 42 of the baffle 38, and the molding surfaces 16A, 16B of the blank mold 12 extending between the surface 40 of the neck ring 22 and the surface 42 of the baffle 38, is now established.

The plunger 36 then extends axially further into the blank mold cavity 20 and presses the glass gob G into the surface 40 of the neck ring 22 and around the end of the plunger 36 and against the remainder of the blank mold cavity surface 18, as shown in FIG. 3, to form a parison P. In a blow-and-blow process, which is not illustrated here, the glass gob G is blown against a plunger (settle blow) and, subsequently, the plunger is withdrawn through the neck ring and a counter blow is applied to finish forming the glass gob G into the parison P in the blank mold cavity 20. As the parison P is formed from the glass gob G, contact between the glass and the relatively cool blank mold 12 causes the glass to cool as thermal energy is extracted from the glass by the bulk material of the mold 12. The flow of cooling fluid C through each of the axial cooling channels 30, in turn, extracts thermal energy from the bulk material of the blank mold 12 to prevent the mold 12 from overheating due to repeated contact with hot glass. The flow of cooling fluid C is depicted while the blank mold 12 is in the closed position, but cooling fluid may also be flowing through the axial cooling channels 30 when the mold 12 is in the open position and/or not flowing during at least a portion of the time the mold 12 is closed.

After the parison P is formed in the blank mold cavity 20, the plunger 36 is retracted axially from the parison P and back through the neck ring 22, the baffle 38 is moved away from the blank mold 12, and the blank mold halves 12A, 12B of the blank mold 12 are separated to open the blank mold 12 from the closed position to the open position. The neck ring 22 remains closed around an open end 44 (FIG. 3) of the parison P that defines a mouth opening, as shown in FIG. 4, and the portion of the parison P retained in the neck ring 22 forms a neck finish 46 of the parison P, which may include external threading, an external circumferential band, an external circumferential lip, or other external and/or internal features. The shape of an exterior surface 48 of the parison P extending from the neck finish 46 is at least partly defined by the molding surfaces 16A, 16B of the blank mold 12 with a base portion 48b of the exterior surface 48 being defined by the surface 42 of the baffle 38. The parison P is then inverted while still retained in the neck ring 22 and is transferred to the blow mold 14 where a subsequent blow molding step occurs. At the blow mold 14, and as the parison P is suspended from the neck ring 22, the blow mold 14 is closed around the parison P, which involves closing a pair of opposed blow mold halves 14A, 14B of the blow mold 14 around the parison P and a bottom plate to establish a blow mold cavity defined by a blow mold cavity surface 52. The neck ring 22 is then opened to release the parison P and is returned to the blank mold 12 for the next container forming cycle.

The parison P is formed into a glass container GC within the blow mold 14 as depicted in FIGS. 5-6. After the blow mold 14 is closed around the parison P and the neck ring 22 is moved away, a blowhead 50 arrives at the blow mold 14. The blowhead 50 surrounds and covers the neck finish 46 of the parison P, which protrudes outside of the blow mold 14, and delivers a compressed fluid F, typically compressed air, through a blow tube that extends into the open end 44 of the parison P. The compressed fluid F supplied into the parison P stretches, outwardly expands, and presses the still flowable glass of the glass parison P against the blow mold cavity surface 52 of the blow mold 14 to form the glass container GC, as illustrated in FIG. 6. After the glass container GC is blown, the blowhead 50 is removed from around the neck finish of the glass container GC and the container GC is retrieved from the blow mold 14. To retrieve the glass container GC, a takeout arm may grip the container GC by the neck finish and the blow mold 14 may thereafter be opened by separating the blow mold halves 14A, 14B away from the glass container GC, or the blow mold 14 may be opened first by separating the blow mold halves 14A, 14B away from the glass container GC and the takeout arm may thereafter grip the neck of the container GC beneath the neck finish. After retrieving the glass container GC, the takeout arm places the container GC on a deadplate where the container GC remains momentarily until being pushed onto a conveyor for transport towards an annealing lehr.

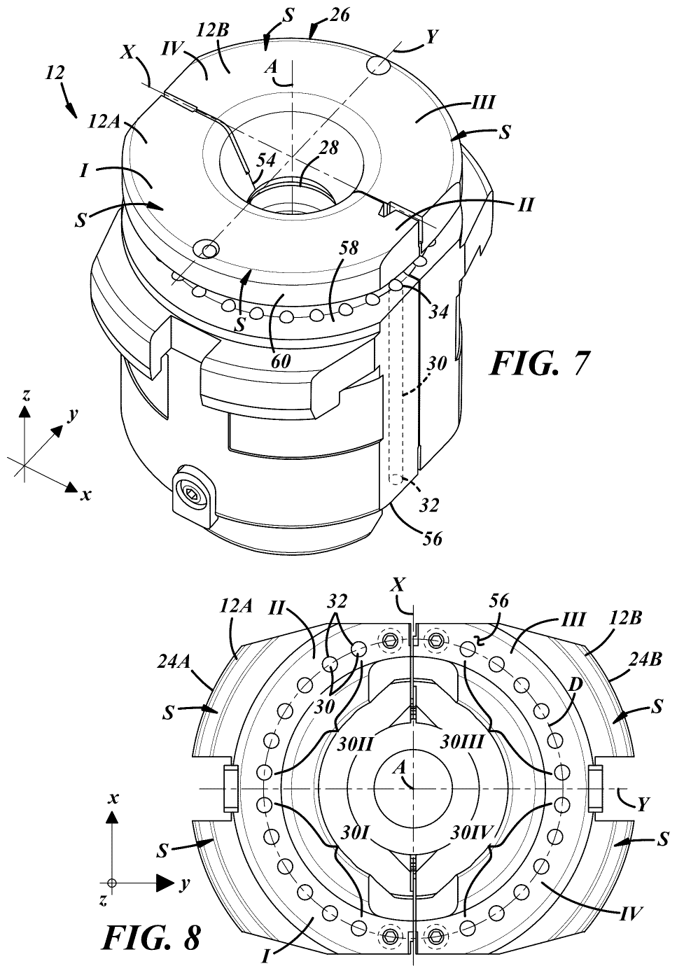

An example of the blank mold 12 is shown in further structural detail in FIGS. 7 and 8 separate from the rest of the glass container forming machine 10. The blank mold 12 includes the first and second blank mold halves 12A, 12B mated with each other at a parting line 54 when in the closed position while also engaging the neck ring (not shown) and establishing the gob opening 28. Each of the blank mold halves 12A, 12B provides their respective molding surface 16A, 16B and one circumferential half of the portion of the blank mold cavity surface 18 provided by the blank mold 12; that is, each blank mold half 12A, 12B constitutes 50% (i.e., 180°) of the circumference of the portion of the blank mold cavity surface 18 established by the blank mold 12 about a central axis A of the blank mold cavity 20. The blank mold halves 12A, 12B are separable and can be moved away from each other to change the mold 12 from the closed position to the open position. The blank mold 12 includes a plurality of the axial cooling channels 30 formed in each of the blank mold halves 12A, 12B radially outboard of the molding surface 16A, 16B. The axial cooling channels 30 are preferably circumferentially spaced around the blank mold 12 and surround the central axis A of the blank mold 12.

The inlet end 32 of each cooling channel 30 opens at a bottom axial end face 56 of the respective blank mold half 12A, 12B at the neck end 24A, 24B and the outlet end 34 of each cooling channel 30 opens on another exterior surface 58 of the corresponding blank mold half 12A, 12B. The outlet end 34 of each axial cooling channel 30 may face a radially overhanging coolant deflector 60 proximate the baffle end 26A, 26B although such a deflector 60 is not necessarily required. The cooling channels 30 extend through their respective blank mold halves 12A, 12B along an axial direction; that is, the channels 30 run parallel to the central axis A of the blank mold cavity 20 of the blank mold 12, which is the z-direction in FIG. 7 and the vertical direction in FIGS. 1-3. However, to be considered an axial cooling channel 30, the cooling channel need not be perfectly parallel with the central axis A and the inlet and outlet ends 32, 34 may be offset. An axial cooling channel 30 is any cooling channel having its inlet and outlet ends 32, 34 spaced apart in the axial direction. The outlet end 34 of each cooling channel 30 is preferably closer to the baffle end 26A 26B of its respective blank mold half 12A, 12B than to the neck end 24A, 24B although in some alternate constructions of the blank mold this may not be the case as the axial cooling channels may only run a short distance. Additionally, as shown in FIG. 8, the axial cooling channels 30 may be arranged in a circular array concentric with the central axis A, and the bottom axial end face 56 may be planar. Additional cooling channels 30 may be defined in the blank mold halves 12A, 12B apart from the array of cooling channels 30 shown here.

The blank mold 12 may be divided into a plurality of sectors S, each of which is an angular or circumferential portion of one of the blank mold halves 12A, 12B that extends axially between the neck and baffle ends 24A, 24B, 26A, 26B of the mold halves 12A, 12B and encompasses at least one of, and preferably a plurality of, the axial cooling channels 30. In the illustrated example, the blank mold 12 includes four sectors S, designated by sector numerals I-IV, which are angularly defined between perpendicular boundaries X and Y. Boundary X is located along the parting line 54 of the blank mold 12, boundary Y is perpendicular to boundary X, and both boundaries X, Y intersect to establish an x-y plane that lies perpendicular to the central axis A. In FIGS. 7-8, the first and second sectors I and II are established in the first blank mold half 12A and are separated by boundary Y, and the third and fourth sectors III and IV are established in the second blank mold half 12B and are also separated by boundary Y. The blank mold 12 and each blank mold half 12A, 12B may be divided into any number of sectors S containing at least one axial cooling channel 30 with the quantity of sectors S preferably ranging from two to six. Some sectors S (e.g., sectors I and IV) are present in different blank mold halves 12A, 12B and are therefore separable from each other, while other sectors (e.g., sectors I and II) are part of the same blank mold half 12A, 12B and are therefore inseparable. The angular extents of all sectors S of the blank mold 12 may be equally sized. In the illustrated example, the angular extent of each of the four sectors I-IV is 90°, and each sector I-IV may be referred to as a quadrant of the blank mold 12. The flow of cooling fluid C to each of the axial cooling channel(s) 30 of each sector S of the blank mold 12 may be separately and/or remotely controlled.

Each of the sectors S of the blank mold 12 encompasses a portion or a subset of the total number of axial cooling channels 30 defined in the blank mold 12 as shown best in FIG. 8. In this example, a first subset of the cooling channels 30I is contained within the first sector I, a second subset of the cooling channels 30II is contained within the second sector II, a third subset of the cooling channels 30III is contained within the third sector III, and a fourth subset of the cooling channels 30IV is contained within the fourth sector IV. The number of axial cooling channels 30 included in the first, second, third, and fourth subsets of the cooling channels 30I, 30II, 30III, 30IV may be the same, as depicted here, or different, and is preferably a plurality of axial cooling channels 30 which, for example, may range from two to twenty cooling channels 30. To enable asymmetric cooling and temperature control of the blank mold 12, the flow of cooling fluid C flow through each of the subsets of the cooling channels 30I, 30II, 30III, 30IV is controlled separately from the other subsets, which allows, for example, the duration of the flow of cooling fluid C, the flow rate of the cooling fluid C, the timing of when the flow of the cooling fluid C through the subsets of cooling channels 30I, 30II, 30III, 30IV begins and ends, and other cooling fluid flow parameters to be individually controlled for each of the subsets of the cooling channels 30I, 30II, 30III, 30IV. Such control may be practiced remotely as described in more detail below.

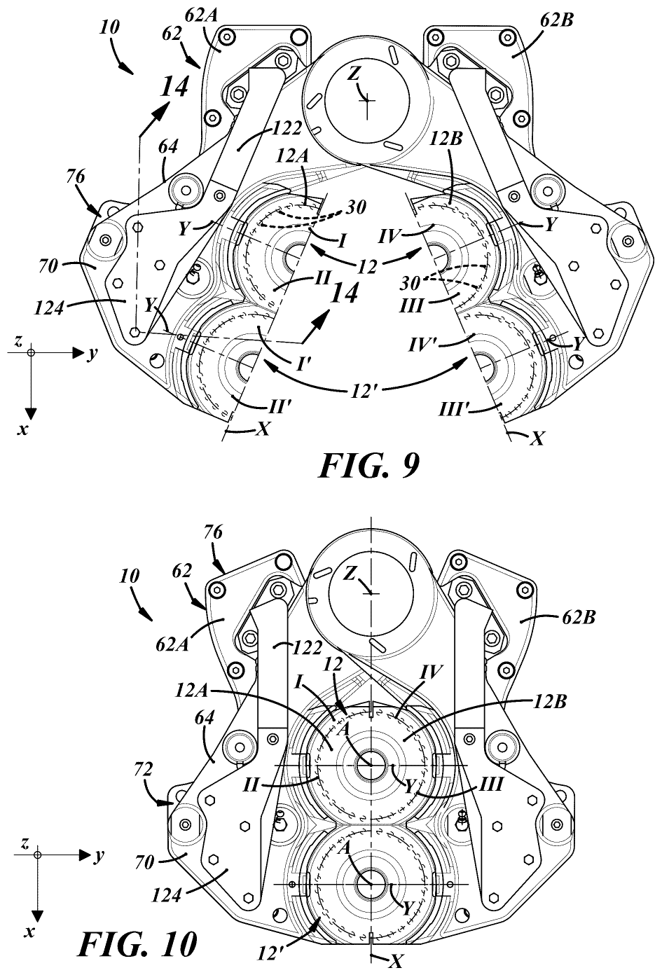

On the blank side of the glass container forming machine 10, the blank mold halves 12A, 12B of the blank mold 12 are carried by a blank mold hanger 62 that facilitates opening and closing of the blank mold 12. As shown in FIGS. 9-10, for example, the blank mold hanger 62 includes first and second blank mold hanger halves 62A, 62B that respectively carry the opposed first and second blank mold halves 12A, 12B of the blank mold 12. The blank mold hanger halves 62A, 62B depicted here also carry a second blank mold 12′ of similar construction to the blank mold 12 described herein (sometimes referred to as the first blank mold 12 for clarity), including having a plurality of sectors I′, II′, III′, IV′, as this particular forming machine 10 is configured as a double gob machine. The description of the first blank mold 12 presented herein thus applies equally to the second blank mold 12′ and, accordingly, only the first blank mold 12 is further discussed below unless a distinction between the blank molds 12, 12′ is necessary. In other embodiments, however, the forming machine 10 may include only one blank mold or it may carry three or four blank molds depending on the number of containers desired to be formed. The blank mold 12 is shown in the open condition in FIG. 9 in which the opposed blank mold halves 12A, 12B have been separated by diverging swiveling movement of the first and second blank mold hanger halves 62A, 62B. Conversely, in FIG. 10 the blank mold 12 is shown in the closed position in which each of the opposed blank mold halves 12A, 12B have been brought together by converging swiveling movement of the blank mold hanger halves 62A, 62B. The outlet end 34 (FIG. 7) of each of the axial cooling channels 30 is shown in hidden lines beneath the coolant deflector 60 of the blank mold halves 12A, 12B.

The blank mold hanger halves 62A, 62B are configured to support and move their respective blank mold halves 12A, 12B of the blank mold 12 between the open position (FIG. 9) and the closed position (FIG. 10) of the mold 12. In the closed position, the first blank mold half 12A of the blank mold 12 cooperates with the second mating blank mold half 12B to form the portion of the blank mold cavity 20 that is provided by the blank mold 12 (the remainder of the blank mold cavity 20 being provided by the neck ring 22 and the baffle 38). In the open position, the first and second blank mold halves 12A, 12B are separated from each other. Movement of each of the first and second blank mold hanger halves 62A, 62B towards and away from each other may be a swiveling movement about a machine axis Z. The machine Z axis may extend perpendicular to the illustrated x-y plane, and the blank mold hanger haves 62A, 62B may be configured to move their respective blank mold halves 12A, 12B along an arcuate path parallel with the x-y plane during movement between the open and closed positions. In other implementations, however, the blank mold hanger halves 62A, 62B may be configured to move their respective blank mold halves 12A, 12B along an arcuate path that is not parallel with, but is instead angled to, the x-y plane. The illustrated x-y plane of the blank mold 12 may or may not be horizontally level with respect to gravity.

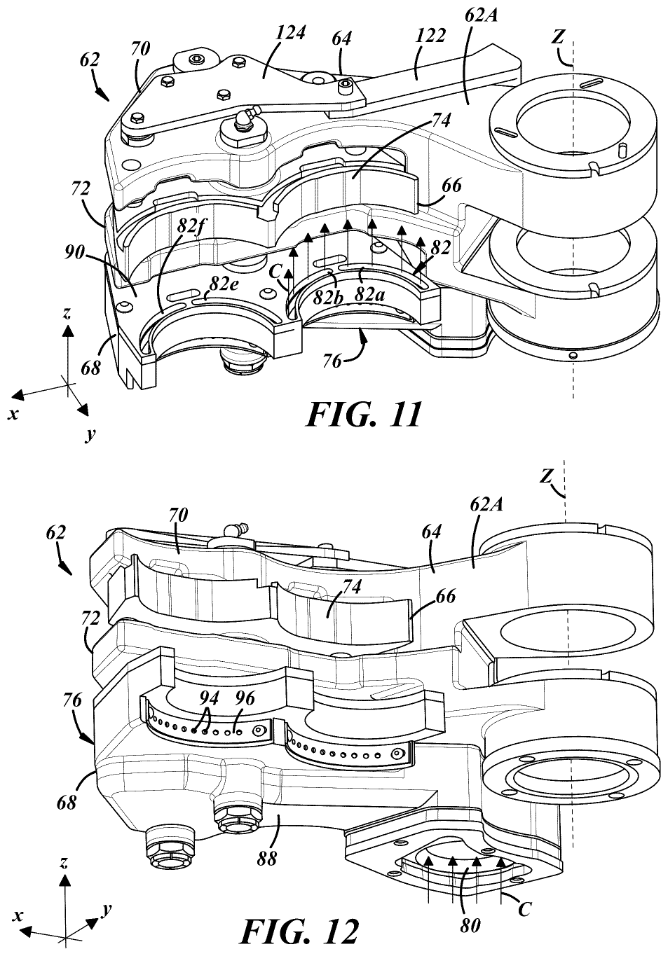

FIGS. 11 and 12 illustrate from above and below, respectively, an inboard side of one of the blank mold hanger halves—specifically, the first blank mold hanger half 62A—in the closed position with its corresponding first blank mold half 12A of the blank mold 12 omitted (the blank mold half of the second blank mold 12′ also being omitted). Even though only one of the blank mold hanger halves 62A is shown here in FIGS. 11-12, the description of the illustrated first blank mold hanger half 62A applies equally to the second blank mold hanger half 62B since the two blank mold hanger halves 62A, 62B share the same construction and function. The blank mold hanger half 62A includes an arm 64, a mold support 66, and a plenum 68. The arm 64 is configured to rotate about the machine axis Z and to support the mold support 66 and the plenum 68 for movement therewith. The mold support 66 is coupled to the arm 64 between opposed upper and lower mounting plates 70, 72 of the arm 64 that are vertically spaced apart along the machine Z axis, although other arrangements for coupling the mold support 66 to the arm 64 are possible. The mold support 66 supports the blank mold half 12A of the blank mold 12 and is configured so that the mold half 12A can be releasably coupled thereto. The mold support 66 has a support surface 74 that extends inward from the arm 64. The support surface 74 confronts and may register with an exterior of the blank mold half 12A when the mold half 12A is coupled to the mold support 66.

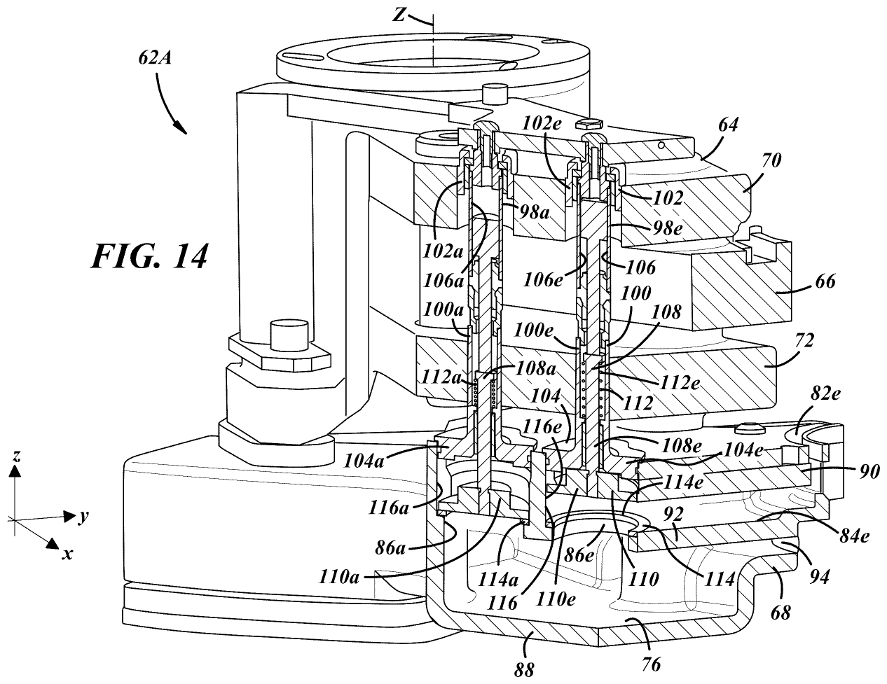

The plenum 68 is typically affixed to and supported by the arm 64, more specifically the lower mounting plate 72 of the arm 64, and forms part a blank mold cooling system 76. In other implementations, the plenum 68 may be separate from the arm 64 such that the two components 64, 68 can experience relative movement therebetween yet be indexed in certain predetermined locations. The plenum 68 supports the blank mold half 12A from below and defines a main interior chamber 78 (FIGS. 14-15) that is supplied with an input flow Cs of cooling fluid when in use as part of the blank mold cooling system 76. Additionally, the plenum 68 defines a cooling fluid inlet 80 (FIGS. 12 and 15) and at least one cooling fluid outlet 82 as shown best in FIGS. 11 and 14. The cooling fluid inlet 80 fluidly communicates with the main interior chamber 78 of the plenum 68 and the number of cooling fluid outlets 82 present depends on the number of sectors S that are present in the blank mold half 12A of the blank mold 12. The cooling fluid outlet(s) 82 provided by the plenum 68 may assume any of a number of configurations. Here, for example, as shown, each of the cooling fluid outlets 82 is configured as an arcuate slot. The plenum 68 also defines a dedicated cooling flow passage 84 for each cooling fluid outlet 82 as shown in FIGS. 14-15. The cooling flow passage 84 extends from a passage opening 86, which connects the flow passage 84 with the main interior chamber 78, to its respective cooling fluid outlet 82 and thus establishes a flow path between the passage opening 86 and the cooling fluid outlet 82.

The plenum 68 may be constructed in various ways to distribute cooling fluid to each cooling fluid outlet 82. In the illustrated example, the cooling fluid inlet 80 is defined by an exterior first wall 88 of the plenum 68 and the one or more cooling fluid outlets 82 are defined by an exterior second wall 90 of the plenum 68 that is spaced apart from the first wall 88. The exterior first wall 88 may be a bottom wall of the plenum 68 and the exterior second wall 90 may be a top wall of the plenum 68. An interior third wall 92 of the plenum 68, which is disposed between the exterior first and second walls 88, 90, defines the passage opening 86 for each cooling flow passage 84. The interior third wall 92 also cooperates with the exterior first wall 88 to define the main interior chamber 78 and additionally cooperates with the exterior second wall 90 to define each of the one or more cooling flow passages 84 that extends between its respective passage opening 86 and its respective cooling fluid outlet 82. The flow of cooling fluid through each of the cooling fluid outlets 82—and, ultimately, the flow of cooling fluid C through each of the axial cooling channels 30 of the sector S of the blank mold 12 corresponding to each of the cooling fluid outlets 82—is separately and remotely controllable. The term “remotely controllable” means that a change in the flow of cooling fluid C through the axial cooling channels 30 of each sector S can be manipulated without physically interacting with the blank mold hanger half. Manually adjusting a flow restrictor valve by hand, or with a physical tool that is manipulated by hand, to change the flow of cooling fluid C does not fall within the definition of “remotely controllable.” On the other hand, using electrical signals to communicate and direct changes to the flow of cooling fluid C through the axial cooling channels 30 of each sector S would fall within the definition of “remotely controllable.”

The plenum 68 preferably provides at least two cooling fluid outlets 82 for the blank mold half 12A carried by the blank mold hanger half 62A. The two cooling fluid outlets 82 may thus include a first cooling fluid outlet 82a and a second cooling fluid outlet 82b. When the blank mold half 12A is supported by the mold hanger half 62A, an interface is formed between the bottom axial end face 56 of the mold half 12A and the exterior second wall 90 of the plenum 68, thus bringing the first cooling fluid outlet 82a into fluidic communication with the axial cooling channel(s) 30 in one sector S of the mold half 12A and the second cooling fluid outlet 82b into fluidic communication with the axial cooling channel(s) 30 of an another sector S within the same mold half 12A. In the specific example shown here, the arcuate slot of the first cooling fluid outlet 82a is axially aligned with and circumferentially spans the first subset of the cooling channels 30I contained within the first sector I of the blank mold 12, and the arcuate slot of the second cooling fluid outlet 82b is axially aligned with and circumferentially spans the second subset of the cooling channels 30II contained within the second sector II of the blank mold 12. As such, the first cooling fluid outlet 82a supplies cooling fluid and thus the cooling fluid flows C to the first subset of the cooling channels 30I of the blank mold 12 within the first blank mold half 12A and, separately, the second cooling fluid outlet 82b supplies cooling fluid and thus the cooling fluid flows C to the second subset of the cooling channels 30II of the blank mold 12 within the same blank mold half 12A.

The plenum 68 may further include one or more cooling fluid holes 94 separate from the cooling fluid outlets 82 for providing cooling fluid to some part of the forming machine 10 other than the axial cooling channels 30 of the blank mold 12, as shown in FIG. 12. For example, the cooling fluid hole(s) 94 may be formed in a vertical arcuate side wall 96 of the plenum 68 that interfaces with the neck ring 22 when the blank mold 12 is in the closed position. The cooling fluid hole(s) 94, which may be a series of holes defined in the vertical arcuate side wall 96, divert cooling fluid from the main interior chamber 78 of the plenum 68 and provide that diverted cooling fluid to the neck ring 22 (FIGS. 1-3). The diverted cooling fluid flows radially with respect to the central axis A—the cooling fluid flowing into the blank mold 12, on the other hand, flows axially through the cooling fluid outlet(s) 82 relative to the central axis A in this embodiment—of the blank mold cavity 20 and into corresponding cooling channels of the neck ring 22 to cool the neck ring 22. The diverted cooling fluid supplied through the cooling fluid hole(s) 94 may be separately controllable with respect to the cooling fluid outlets 82 or may simply be flowing or not flowing depending on whether the main interior chamber 78 of the plenum 68 is pressurized with cooling fluid. Here, as shown, the cooling fluid hole(s) 94 communicate directly with the main interior chamber 78, thus allowing cooling fluid to flow directly from the main interior chamber 78 and through the hole(s) 94 without any further controls in place.

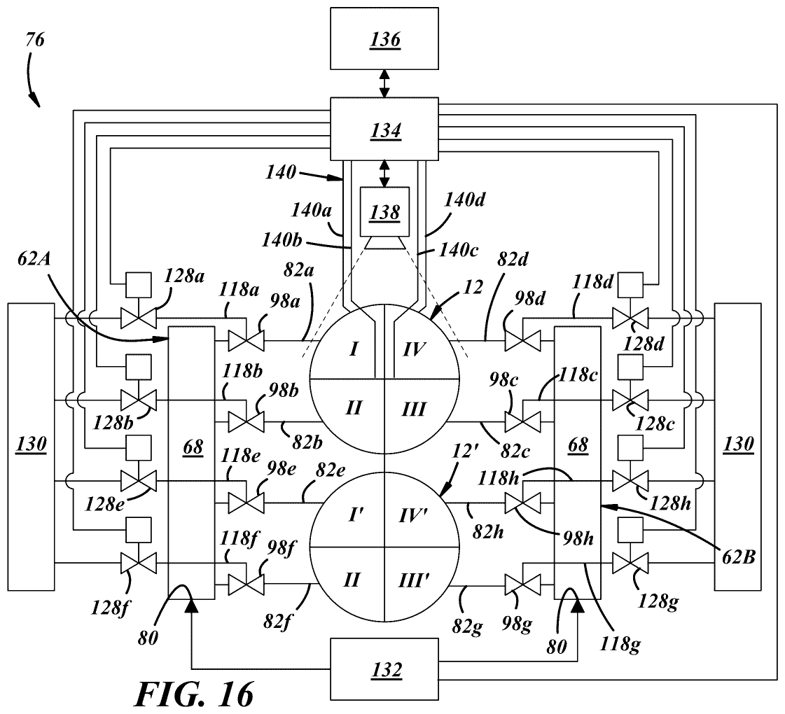

The other second blank mold hanger half 62B, which is not illustrated in FIGS. 11-12, is constructed in the same way as the first mold hanger half 62A. The second mold hanger half 62B defines a cooling fluid inlet 80 and at least one cooling fluid outlet 82 and, preferably, at least two cooling fluid outlets 82. When the corresponding second blank mold halve 12B of the blank mold 12 is supported by the second mold hanger half 62B, and in the specific example shown here, a third cooling fluid outlet 82c is brought into fluidic communication with the axial cooling channel(s) 30 in one sector S of the blank mold half 12B and a fourth cooling fluid outlet 82d is brought into fluidic communication with the axial cooling channel(s) 30 of an another sector S within the same blank mold half 12B, as shown schematically in FIG. 16. Each of the third and fourth cooling fluid outlets 82c, 82d may be defined by a respective arcuate slot as before. To that end, in this example, the arcuate slot of the third cooling fluid outlet 82c is axially aligned with and circumferentially spans the third subset of the cooling channels 30III contained within the third sector III of the blank mold 12, and the arcuate slot of the fourth cooling fluid outlet 82d is axially aligned with and circumferentially spans the fourth subset of the cooling channels 30IV contained within the fourth sector IV of the blank mold 12. As such, the third cooling fluid outlet 82c supplies cooling fluid and thus the cooling fluid flows C to the third subset of the cooling channels 30III of the blank mold 12 within the second blank mold half 12B and, separately, the fourth cooling fluid outlet 82d supplies cooling fluid and thus the cooling fluid flows C to the fourth subset of the cooling channels 30IV within the same blank mold half 12B. The plenum 68 of the second mold hanger half 62B may also include one or more cooling fluid holes 94 similar to those described above.

Referring back to the first blank mold hanger half 62A shown in FIGS. 11-12, the illustrated plenum 68 defines additional cooling fluid outlets 82e, 82f that supply cooling fluid to the axial cooling channels 30 contained in the first and second sectors I′, II′ of the second blank mold 12′ in the same way as previously described. Each of the additional cooling fluid outlets 82e, 82f receives cooling fluid via a cooling flow passage 84 that provides a flow path from a corresponding passage opening 86 that connects the cooling flow passage 84 to the main interior chamber 78 of the plenum 68. Similarly, and while not shown here in FIGS. 11-12, the plenum 68 of the opposed second blank mold hanger half 62B likewise defines additional cooling fluid outlets 82g, 82h to supply cooling fluid to the axial cooling channels 30 contained in the individual third and fourth sectors III′, IV′ of the second blank mold 12′. The flow of cooling fluid from each of the cooling fluid outlets 82e, 82f, 82g, 82h that provide cooling fluid to the second blank mold 12′ is also separately and remotely controllable with respect to each other and with respect to each of the other cooling fluid outlets 82a, 82b, 82c, 82d associated with the first blank mold 12.

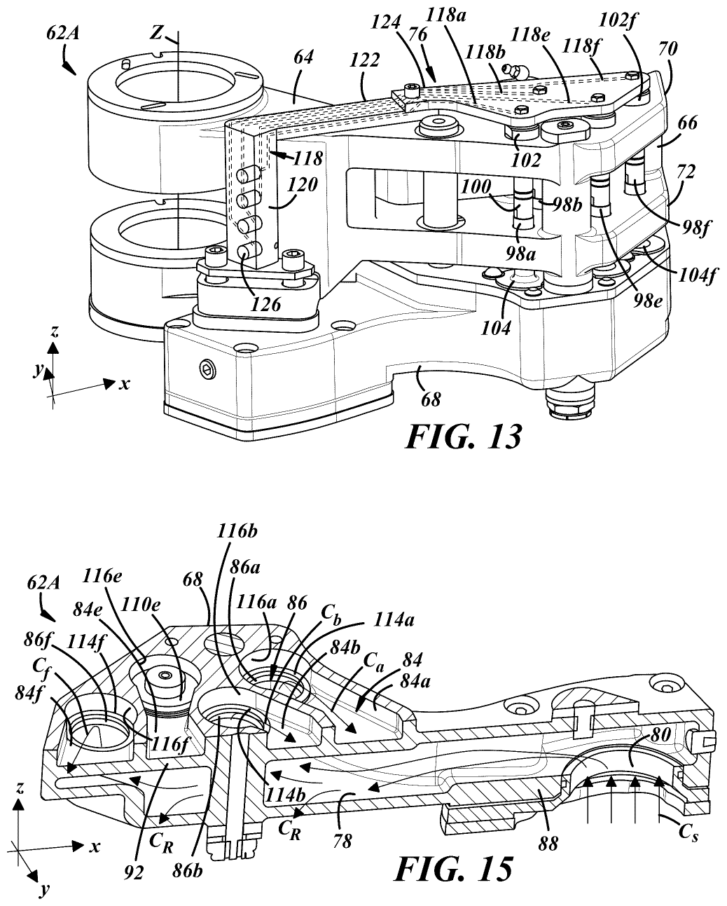

Each of the two blank mold hanger halves 62A, 62B includes one or more flow control valves 98; that is, one flow control valve 98 is associated with each cooling fluid outlet 82 to control the flow of the cooling fluid to its respective cooling fluid outlet 82 as shown in FIGS. 13-15 in the context of the first blank mold hanger half 62A. Each flow control valve 98 is carried by the arm 64 of the mold hanger half 62A and forms part of the cooling system 76. The flow control valve 98 is operable to control the flow of cooling fluid to the corresponding cooling fluid outlet 82 defined in the plenum 68. In the first blank mold hanger half 62A shown here in FIGS. 13-15, for example, and as also depicted schematically in FIG. 16, four flow control valves 98a, 98b, 98e, 98f are provided—two for the first blank mold half 12A of the blank mold 12 and two for the same mold half of the second blank mold 12′. Specifically, first and second flow control valves 98a, 98b associated with the first blank mold 12 separately control the flow of cooling fluid from the plenum 68 to the first and second cooling fluid outlets 82a, 82b, respectively, and thus the flow of the cooling fluid flows C to the corresponding first subset of the cooling channels 30I contained within the first sector I of the blank mold 12 and to the second subset of the cooling channels 30II contained within the second sector II of the same blank mold 12. Similarly, two additional flow control valves 98e, 98f associated with the second blank mold 12′ separately control the flow of cooling fluid from the plenum 68 to their corresponding cooling fluid outlets 82e, 82f, respectively, and thus the flow of the cooling fluid flows C to the cooling channels contained in the first and second sectors I′, II′ of the second blank mold 12′.

The second opposed blank mold hanger half 62B, while not shown in FIGS. 13-15, also includes a flow control valve 98 associated with each cooling fluid outlet 82 in the same way as illustrated in the first blank mold hanger half 62A. The flow control valve 98 is similarly operable to control the flow of cooling fluid to the corresponding cooling fluid outlet 82 defined in the plenum 68 of the second blank mold hanger half 62B. As shown schematically in FIG. 16, for example, four flow control valves 98c, 98d, 98g, 98h are provided—two for the second blank mold half 12B of the blank mold 12 and two for the same mold half of the second blank mold 12′. Specifically, third and fourth flow control valves 98c, 98d associated with the first blank mold 12 separately control the flow of cooling fluid from the plenum 68 to the third and fourth cooling fluid outlets 82c, 82d, respectively, and thus the flow of the cooling fluid flows C to the corresponding third subset of the cooling channels 30III contained within the third sector III of the blank mold 12 and to the fourth subset of the cooling channels 30IV contained within the fourth sector IV of the same blank mold 12. Similarly, two additional flow control valves 98g, 98h associated with the second blank mold 12′ separately control the flow of cooling fluid from the plenum 68 to their corresponding cooling fluid outlets 82g, 82h, respectively, and thus the flow of the cooling fluid flows C to the cooling channels contained in the third and fourth sectors III′, IV′ of the second blank mold 12′.

Each flow control valve 98 may be similarly constructed. In that regard, the following description of the valve 98 with its identified features in FIGS. 13-14 in relation to the first flow control valve 98a associated with the first subset of the cooling channels 30I contained within the first sector I of the blank mold 12, as well as the flow control valve 98e associated with the same sector of the second blank mold 12′, applies equally to all of the other flow control valves carried by the blank mold hanger halves 62A, 62B. The flow control valve 98 has a barrel 100 that extends between a cap 102 at one end and a base 104 at an opposite end. The cap 102 is received in and preferably coupled to the arm 64 while the base 104 is received in and preferably coupled to the plenum 68, although in some embodiments the base 104 may not be coupled to the plenum 68. The barrel 100 defines an interior bore 106. The barrel 100, cap 102, and base 104 may be unitary in construction or provided fully or partially by separate pieces of the valve 98 that are connected together. Here, the cap 102 is coupled to the upper mounting plate 70, the base 104 is coupled to the exterior second wall 90 of the plenum 68, and the barrel 100 extends through the lower mounting plate 72 between the cap 102 and the base 104. This arrangement makes establishing a connection with the valve 98 easier and provides ready access to the valve 98 in the event the valve 98 needs maintenance or replacement. In other examples, however, the cap 102 of the flow control valve 98 may be coupled to the lower mounting plate 72 of the arm 64 such that the barrel 100 does not extend through the lower mounting plate 72.

Additional details of the flow control valve 98 are illustrated in FIG. 14, which shows the first flow control valve 98a associated with the first subset of the cooling channels 30I contained within the first sector I of the first blank mold 12, as well as the flow control valve 98e associated with the same sector I′ of the second blank mold 12′, in cross-section. The flow control valve 98 additionally includes a valve stem 108 that is linearly actuatable within the interior bore 106 of the barrel 100, and a valve plug 110, which here is in the form of a disc, connected to a distal end of the valve stem 108 and disposed outside of the barrel 100 and beyond the base 104 of the valve 98. The valve plug 110 is linearly displaceable by the valve stem 108 axially with respect to the base 104. The valve stem 108 may be a single unitary piece or, as shown, for example, the valve stem 108 may be comprised of multiple pieces that are coupled together or are uncoupled yet move in unison. In this embodiment, the valve stem 108 is comprised of an upper piece and a lower piece, each of which has a top end and a bottom end. The top end of the upper piece is proximate the cap 102 and the bottom end is contained within the interior bore 106 of the barrel 100. The lower piece extends through the base 104 of the valve 98 and its top end, which is contained within the interior bore 106, is physically abutted by the bottom end of the upper piece. The bottom end of the lower piece, which constitutes the distal end of the valve stem 106, is outside of the barrel 100 and is secured to the valve plug 110.

The flow control valve 98 also includes a biasing element 112 that biases the valve stem 108 towards or away from a valve seat 114 provided by the plenum 68. The valve seat 114 circumscribes the respective passage opening 86 with which the flow control valve 98 corresponds and may be a radially extending surface of the plenum 68 shaped to mate with the valve plug 110. The plenum 68 may also provide a guide wall 116 that extends axially away from the valve seat 114 and partially surrounds the passage opening 86 to maintain flow communication with the cooling flow passage 84. A partial circumferential portion of the valve plug 110 of the flow control valve 98 contacts and slides against the guide wall 116 during linear movement of the plug 110. The biasing element 112 may be a spring such as, for example, a compression spring that acts on the valve stem 108 either directly or indirectly. The biasing element 112 also be something other than a spring including, for example, a compressible material.

The biasing force of the biasing element 112 is opposable by an actuation force, which may be pneumatically applied as described below. By applying the actuation force, the valve stem 108 is axially moved in one axial direction against the biasing force to move the valve plug 110 from a rest position to an actuated position. Likewise, in the absence of the actuation force, the biasing force moves the valve stem 108 in the opposite axial direction and returns the valve plug 110 to the rest position from the actuated position. In the illustrated example, each of the flow control valves 98 is biased to an open position of the valve 98 in which the valve plug 110 is spaced apart from the valve seat 114 (i.e., here, the rest position of the valve plug 110 corresponds to the open position of the valve 98). When the flow control valve 98 is actuated, the actuation force overcomes the biasing force of the biasing element 112 and extends the valve stem 108 out of the barrel 100 to move the valve plug 110 into a closed position of the valve 98 in which the valve plug 110 is seated against the valve seat 114 (i.e., here, the actuated position of the valve plug 110 corresponds to the closed position of the valve 98). Eventually, when the actuation force is removed, the biasing force of the biasing element 112 retracts the valve stem 108 into the barrel 100 and separates the valve plug 110 from the valve seat 114 to return the valve 98 back to the open position. Of course, the biasing element 112 could be configured to bias the valve stem 108 in the opposite axial direction towards the valve seat 114 so that the actuation force moves the valve plug 110 in the opposite axial direction away from the valve seat 114 of the respective passage opening 86.

In FIG. 14, the first flow control valve 98a is illustrated in the closed position and the other flow control valve 98e is illustrated in the open position. The valve plug 110a of the first flow control valve 98a in the closed position makes sealing contact with its respective valve seat 114a and the valve plug 110e of the other flow control valve 98e in the open position is axially separated from its respective valve seat 114e. In this embodiment, the valve plug 110 of each flow control valve 98 moves axially between its rest and actuated positions above the passage opening 86 to its respective cooling flow passage 84 such that actuated extension the valve stem 108 moves the valve plug 110 towards the passage opening 86 and biased retraction the valve stem 108 moves the valve plug 110 away from the opening 86. In other embodiments, however, the valve plug 110 of each flow control valve 98 may move axially between its rest and actuated positions below the passage opening 86 of its respective cooling flow passage 84 within the main interior chamber 78 such that actuated extension the valve stem 108 moves the valve plug 110 away from the passage opening 86 and biased retraction the valve stem 110 moves the valve plug towards the opening 86.

Each flow control valve 98 may be selectively actuated. For example, each flow control valve 98 may be pneumatically actuated, although other forms of actuation are possible. With reference to FIG. 13, pneumatic actuation of the flow control valve 98 is enabled by a pneumatic line 118 that supplies pressurized actuation fluid to the valve 98 and, more specifically, into the interior bore 106 of the barrel 100 through an inlet opening in the cap 102 of the valve 98. Here, the pneumatic line 118 is routed from a connector block 120 to the valve 98 through a connector block housing 122 and a distribution housing 124 that extends from the connector block housing 122 over the arm 64 of the blank mold hanger half 62A and the flow control valve(s) 98. This arrangement allows remote actuation of the flow control valve 98 by selectively supplying actuation fluid, under pressure, to a port 126 of the connector block 120 and thereby to the flow control valve 98 through the pneumatic line 118 that connects the port and the valve 98. The actuation fluid may be supplied to the port by a secondary valve 128 such as, for example, a solenoid valve (FIG. 16). The secondary valve 128 communicates with an actuation fluid source 130 that is separate from the source of cooling fluid supplied to the blank molds 12, 12′ and may be located away from the mold hanger half 62A. Other options for delivering the actuation fluid to flow control valve(s) 98 other than through a pneumatic line 118, such as through a manifold, for example, may also be employed.

The actuation fluid source 130 may be any source of a pressurized actuation fluid, such as pressurized air supplied by an air compressor, and the actuation fluid may be controllably supplied to each of the flow control valves 98 by a dedicated secondary valve 128. The secondary valve 128 for each flow control valve 98, which again is preferably a solenoid valve, thus acts as a switch and the flow control valve 98 acts as a remotely actuated relay to control the flow of cooling fluid from the main interior chamber 78 of the plenum 68, through the corresponding passage opening 86 and cooling flow passage 84, and eventually through the corresponding cooling fluid outlet 82 of the plenum 68. While the flow control valves 98 shown and described here include the valve stem 108 and valve plug 110, and are preferably pneumatically actuated, valves of different shapes, constructions, and actuation type (e.g., electric or geared) are also contemplated and may be employed instead. Selective actuation of electric, geared, and other types of flow control valves is contemplated for use in the cooling system 76.

The manner in which the flow control valves 98 can separately control the flow of cooling fluid to corresponding cooling fluid outlets 82 through selective actuation is illustrated generally in FIG. 15 (the positions of the flow control valves 98 in FIGS. 14 and 15 are not the same). There, the flow of cooling fluid through the plenum 68 is broken down into individual component flows, beginning with the input flow C_{S} of the cooling fluid, which is supplied from a cooling fluid source 132 (FIG. 16) to the cooling fluid inlet 80 of the blank mold hanger half 62A (and similarly to the second blank mold hanger half 62B). Various flows of the cooling fluid within the main interior chamber 78 as supplied by the input flow C_{S} of the cooling fluid are then directed through and out of the plenum 68. These various flows include (i) flows of diverted cooling fluid C_{R} that exit the cooling fluid hole(s) 94 (not shown in FIG. 15) for cooling the neck ring 22 as well as (ii) separate flows of cooling fluid Cₐ, C_{b}, C_{f} within respective cooling flow passages 84a , 84b, 84f leading to the corresponding cooling fluid outlets 82a, 82b, 82f and the associated axial cooling channels 30 of the blank molds 12, 12′. The flows of cooling fluid Cₐ, C_{b}, C_{f} to the cooling fluid outlets 82a, 82b, 82f is permitted since the flow control valves (not shown in FIG. 15) that control flow from the main interior chamber 78 into the cooling flow passages 84a, 84b, 84f that respectively communicate with the cooling fluid outlets 82a, 82b, 82f are in the open position and the cooling fluid flows Cₐ, C_{b}, C_{f} are able to pass through the corresponding passage openings 86a, 86b, 86f. Conversely, as shown here, the flow control valve 98e associated with the cooling fluid outlet 82e through which cooling fluid is not flowing is in the closed position and, consequently, the seated valve plug 110e is blocking cooling fluid from passing through the passage opening 86e and entering the cooling flow passage 84e that leads to the corresponding cooling fluid outlet 82e.

Each of the flow control valves 98 may operate as a two-position valve—that is, the valve plug 110 is movable between two valve positions and may not be set to proportionally-based variable positions. In the illustrated example, the two valve positions are the open position of the flow control valve 98, in which the valve plug 110 is in its rest position separated from the valve seat 114, and the closed position of the flow control valve 98, in which the valve plug 110 is in its actuated position and seated against the valve seat 114, although as described above the rest/actuated positions of the valve plug 110 can be switched. In other two-position valve operational configurations, the two valve positions may both be open positions—namely, an open position and a partially open position. In the open position, as before in the open-closed two-position configuration, no actuation force is applied to the valve stem 108 and the valve plug 110 is in its rest position. In the partially open position, the actuation force is applied to the valve stem 108, but the valve plug 110 is not seated against the valve seat 114, although the valve plug 110 is closer to the valve seat 114 than when the valve 98 is in the open position. And while two-position valve operation may provide certain benefits, as explained in more detail below, the flow control valves 98 could also be constructed and operated as variable flow valves that are proportionally responsive while still realizing the benefits associated with separate and remote controllability.

Two-way valve operation simplifies control of the flow of cooling fluid to each sector S of the blank mold 12 since it renders automation easier to implement and does not require fine adjustments of the cooling fluid flow rates through the plenum 68. Indeed, a duration of the flow of cooling fluid through each cooling fluid outlet 82a, 82b, 82c, 82d in the plenums 68 of the first and second blank mold hanger halves 62A, 62B may be controlled to dictate how much cooling fluid flows through the first, second, third, and fourth subsets of the cooling channels 30I, 30II, 30III, 30IV of the first, second, third, and fourth sectors S of the blank mold 12 in any given period of time to separately manage the temperature of the first, second, third, and fourth sectors S of the blank mold 12. For example, a duty cycle or a valve-open duration of each flow control valve 98 as a percentage of a forming cycle duration may be adjusted at any time to change the temperature of the sector S of the blank mold 12 corresponding to the flow control valve 98. The duty cycle or valve open duration of the flow control valve 98 is the time period in which the valve 98 is in the open position and cooling fluid is flowing to and through the respective cooling fluid outlet 82 and as a result the flows of cooling fluid C are flowing into and through the axial cooling channels 30 of the respective sector S of the blank mold 12. A longer valve-open duration allows the cooling fluid flow C to each of the associated axial cooling channels 30 of the respective sector S of the blank mold 12 to flow for a longer period of time, which in turn equates to more cooling fluid passing through the sector S of the blank mold 12 during the valve-open duration. A longer valve-open duration extracts more heat from that particular sector S of the mold 12 and, thus, reduces the temperature of that sector S of the mold 12 accordingly compared to a shorter valve-open duration.

Referring now to FIG. 16, a schematic illustration of the blank mold cooling system 76 in accordance with the above description is shown. The cooling system 76 manages the flow of cooling fluid flowing through the one or more individual sectors I, II, III, IV of the blank mold 12. When the blank mold 12 is coupled to the opposed blank mold hanger halves 62A, 62B, as described above, the first blank mold half 12 of the blank mold 12 includes the first and second sectors or quadrants I, II containing, respectively, the first and second subsets of the cooling channels 30I, 30II in fluidic communication with the plenum 68 of the first blank mold hanger half 62A, and the second blank mold half 12B of the blank mold 12 includes the third and fourth sectors or quadrants III, IV containing, respectively, the third and fourth subsets of the cooling channels 30III, 30IV in fluidic communication with the plenum 68 of the second blank mold hanger half 62B. The cooling fluid inlet 80 of the plenum 68 of each blank mold hanger half 62A, 62B is in fluidic communication with the external cooling fluid source 132, which may be a wind box that provides cooling fluid to the entire glass container forming machine 10. In addition to the flow control valves 98 and the plenum 68 of each blank mold hanger half 62A, 62B, the cooling system 76 also includes a system controller 134 to operate the flow control valves 98a, 98b, 98c, 98d. Through selective actuation of the flow control valves 98a, 98b, 98c, 98d, the system controller 134 is able to separately and remotely control the flow of cooling fluid to each of the first, second, third, and fourth subsets of the cooling channels 30I, 30II, 30III, 30IV of the first, second, third, and fourth sectors S of the blank mold 12, respectively.

The plenums 68 of the first and second blank mold hanger halves 62A, 62B provide the cooling fluid outlets 82a, 82b, 82c, 82d that fluidly communicate with, respectively, the first, second, third, and fourth subsets of the cooling channels 30I, 30II, 30III, 30IV of the first, second, third, and fourth sectors or quadrants I, II, III, IV of the blank mold 12. The flow of cooling fluid through each of the cooling fluid outlets 82a, 82b, 82c, 82d and into the corresponding first, second, third, and fourth subsets of the cooling channels 30I, 30II, 30III, 30IV of the first, second, third, and fourth sectors or quadrants I, II, III, IV is controlled by the corresponding flow control valve 98a, 98b, 98c, 98d. Here, in this example, each flow control valve 98a, 98b, 98c, 98d is pneumatically actuated through a dedicated pneumatic line 118a, 118b, 118c, 118d. Each of the pneumatic lines 118a, 118b, 118c, 118d is supplied with actuation fluid, such as pressurized air, from the actuation fluid source 130 through its corresponding secondary valve 128a, 128b, 128c, 128d. A first end of each pneumatic line 118a, 118b, 118c, 118d is connected to the port in the connector block 120 through which the flow of actuation fluid is selectively controlled by the respective secondary valve 128a, 128b, 128c, 128d. A second end of each pneumatic line is connected to the respective flow control valve 98a, 98b, 98c, 98c. The actuation fluid source 130 is separate from the cooling fluid source 132 and has different requirements including, for example, not requiring as high of a volumetric capacity as the cooling fluid source 132.

Each secondary valve 128a, 128b, 128c, 128d is in electrical communication with the system controller 134. The system controller 134 is operable to selectively actuate each of the secondary valves 128a, 128b, 128c, 128d when prompted to selectively supply or block actuation fluid to the corresponding flow control valves 98a, 98b, 98c, 98d. Supplying actuation fluid to any of the flow control valves 98a, 98b, 98c, 98d moves the valve plug 110 of the valve 98a, 98b, 98c, 98d to the actuated position while, to the contrary, blocking actuation fluid causes the valve plug 110 of the valve 98a, 98b, 98c, 98d to return to the rest position under the biasing force of the biasing element 112. In the blank mold hanger halves 62A, 62B depicted here, the actuated position of the valve plug 110 of the flow control valves 98a, 98b, 98c, 98d equates to the valves 98a, 98b, 98c, 98d being in the closed (or partially open) position and the rest position of the valve plug 110 of the flow control valves 98a, 98b, 98c, 98d equates to the valves 98a, 98b, 98c, 98d being in the open position. While the secondary valves 128a, 128b, 128c, 128d are illustrated at separate locations in the schematic of FIG. 16, the valves 128a, 128b, 128c, 128d may be grouped together as part of a valve bank connected to a common actuation fluid source 130. In the same way, and through selective actuation of the flow control valves 98e, 98f, 98g, 98h, the cooling system 76 shown here is able to separately and remotely control the flow of cooling fluid to each of the first, second, third, and fourth sectors I′, II′, III′, IV′ of the second blank mold 12′ as well.

The system controller 134 is configured to receive input information indicating an adjustment to the flow of cooling fluid to one or more sectors I, II, III, IV of the blank mold 12. The input information may be received from a human-machine interface (HMI) 136, such as a computer with a keyboard, buttons, or touch-screen, and/or from data collectors such as a thermal imager 138 and/or temperature sensors 140. The thermal imager 138, which is preferably an infrared camera, may be positioned above the blank mold 12 and takes thermal images of each of the one or more sectors I, II, III, IV of the blank mold 12 at one or more instances during one or more forming cycles to measure a temperature T_{I}, T_{II}, T_{III}, T_{IV} of each sector I, II, III, IV of the blank mold 12. Each of the thermal sensors 140 may be a thermocouple, a thermistor, or an RTD, to name but a few examples, and each of the one or more sectors I, II, III, IV of the blank mold 12 may be equipped with a temperature sensor 140a, 140b, 140c, 140d to measure the temperature T_{I}, T_{II}, T_{III}, T_{IV} of the sectors I, II, III, IV of the blank mold 12. The HMI 136 and, if present, the thermal imager 138 and/or the thermal sensors 140, electrically communicate with the process controller 134 so that information can be shared with the controller 134.

The controller 134 obtains flow control instructions from the input information. The flow control instructions indicate how to selectively actuate one or more of the flow control valves 98a, 98b, 98c, 98d to adjust the flow of cooling fluid to any of the one or more sectors I, II, III, IV of the blank mold 12 and, thus, to adjust the flows of cooling fluid C to the corresponding axial cooling channels 30 in those sectors I, II, III, IV. Such selective actuation is carried out so that the temperature T_{I}, T_{II}, T_{III}, T_{IV} of at least one of the sectors I, II, III, IV of the blank mold 12 is modified to be different than or equal to the temperature T_{I}, T_{II}, T_{III}, T_{IV} of at least one other sector I, II, III, IV of the blank mold 12. The temperature difference established between the at least one of the sectors I, II, III, IV of the blank mold 12 and the at least one other sector I, II, III, IV of the blank mold 12, which may be measured by the thermal imager 138 and/or the thermal sensors 140, causes a change in temperature to a corresponding portion or portions of a glass parison P received in the blank mold 12. In addition to being configured to receive the input information and to obtain the flow control instructions from the input information, the system controller 134 is also programed to execute the flow control instructions and to control the flow of cooling fluid to the one or more of the sectors I, II, III, IV of the blank mold 12 by selectively actuating the one or more of the flow control valves 98a, 98b, 98c, 98d that correspond to the one or more sectors I, II, III, IV of the blank mold 12 as specified in the flow control instructions.

The input information received by the controller 134 and from which the flow control instructions are obtained may take on a variety of forms. For example, the input information may include the flow control instructions already and be received from the HMI 136 in response to an individual, such as an operator or engineer, entering the flow control instructions directly into the HMI 136. The input information may also include temperature change instructions received from the HMI 136. The temperature change instructions indicate how the temperature T_{I}, T_{II}, T_{III}, T_{IV} of at least one of the sectors I, II, III, IV of the blank mold 12 is to be modified to be different than or equal to the temperature T_{I}, T_{II}, T_{III}, T_{IV} of at least one other sector I, II, III, IV of the blank mold 12. Such a temperature difference between the at least one of the sectors I, II, III, IV of the blank mold 12 and the at least one other sector I, II, III, IV of the blank mold 12, which again may be measured by the thermal imager 138 and/or the thermal sensors 140, may be established to cause a change in temperature to a corresponding portion or portions of a glass parison P received in the blank mold 12. The process controller 134 may reference a programed file, such as an algorithm, to convert the temperature change instructions into flow control instructions that indicate how to selectively actuate one or more of the flow control valves 98a, 98b, 98c, 98d to adjust the flow of cooling fluid to any of the one or more sectors I, II, III, IV of the blank mold 12 to achieve the desired temperature modification.

Still further, the input information may include temperature measurement data received from the thermal imager 138 and/or the thermal sensors 140. Upon receiving temperature measurement data, the process controller 134, in addition to possibly receiving input information from the HMI 136, may reference a programmed application, such as an algorithm, to convert the temperature measurement data into flow control instructions that indicate how to selectively actuate one or more of the flow control valves 98a, 98b, 98c, 98d to adjust the flow of cooling fluid C to any of the one or more sectors I, II, III, IV of the blank mold 12. In this way, an individual may set a temperature set point T_{IS}, T_{IIS}, T_{IIIS}, T_{IVS} for one or more sectors I, II, III, IV of the blank mold 12 through the HMI 136 with the temperature set point T_{IS}, T_{IIS}, T_{IIIS}, T_{IVS} of at least one of the sectors I, II, III, IV of the blank mold 12 being different than or equal to the temperature set point T_{IS}, T_{IIS}, T_{IIIS}, T_{IVS} of at least one other sector I, II, III, IV of the blank mold 12. The process controller 134 then monitors the temperature T_{I}, T_{II}, T_{III}, T_{IV} of the sectors I, II, III, IV of the blank mold 12, generates flow control instructions, and adjusts the flow of cooling fluid to one or more of the sector(s) I, II, III, IV, as needed, as specified by the flow control instructions to maintain the temperature T_{I}, T_{II}, T_{III}, T_{IV} of the one or more sectors I, II, III, IV of the blank mold 12 at the corresponding temperature set point T_{IS}, T_{IIS}, T_{IIIS}, T_{IVS}. As another option, the input information may be received from glass container inspection/evaluation equipment and the process controller 134 may generate flow control instructions that indicate how to selectively actuate one or more of the flow control valves 98a, 98b, 98c, 98d to adjust the flow of cooling fluid C to any of the one or more sectors I, II, III, IV of the blank mold 12 to optimize glass distribution in the glass containers.

The flow of cooling fluid C to any one or more of the sectors I, II, III, IV of the blank mold 12 may be adjusted in at least one of several ways and is specified in the flow control instructions. One way to adjust the flow of cooling fluid C is by modifying the duration during which cooling fluid C flows to the one or more of the sectors I, II, III, IV of the blank mold 12. The duration during which cooling fluid C flows may be defined by degrees of the glass container forming machine cycle or as an interval of time (e.g., time in milliseconds). Indeed, the timing of the glass container forming cycle carried out by the forming machine 10 may be represented in terms of angular degrees of the cycle, with 360 angular degrees representing one complete cycle of the machine 10. The cycle begins at some point, such as when the blank mold 12 closes, which is designated as 0 degrees, and ends when the machine completes the remainder of the repeating cycle and is ready to be closed again prior to receiving the next molten glass gob G, which is designated as 360 degrees. The duration of cooling fluid flow may be increased by increasing the degree range (e.g., from “on” at 100 degrees to “off” at 230 degrees for a duration of 130 degrees to “on” at 80 degrees to off at “260” degrees for a duration of 180 degrees) during which the flow control valve 98 is open to the open position to permit cooling fluid to flow into the cooling fluid outlet 82. Likewise, decreasing the duration of cooling fluid flow is accomplished by decreasing the degree range during which the flow control valve 98 is opened.

Another way to adjust the flow of cooling fluid is by modifying the time during the forming cycle at which the flow of cooling fluid to any of the sectors I, II, III, IV of the blank mold 12 starts and/or stops. The timing of the flow of cooling fluid may be shifted within the forming cycle such that, for example, the flow control valve 98 is opened to the open position to permit cooling fluid to flow into the cooling fluid outlet 82 earlier (e.g., from “on” at 50 degrees to “on” at 10 degrees) or later (e.g., from “on” at 50 degrees to “on” at 80 degrees) in the forming cycle while maintaining the same duration, meaning the time at which the flow control valve 98 is closed to block cooling fluid from flowing into the cooling fluid outlet 82 is shifted earlier or later by the same quantity. The timing of the flow of cooling fluid may also be shifted within the forming cycle such that the flow control valve 98 is closed to block cooling fluid from flowing into the cooling fluid outlet 82 earlier (e.g., from “off” at 220 degrees to “off” at 200 degrees) or later (e.g., from “off” at 210 degrees to “off” at 260 degrees) in the forming cycle while maintaining the same duration, meaning the time at which the flow control valve is opened to permit cooling fluid to flow into the cooling fluid outlet 82 is shifted earlier or later by the same quantity. Adjusting the timing of the flow of cooling fluid may result in a temperature change in one or more sectors I, II, III, IV of the blank mold 12 since the cooling fluid has different effects on the temperature of the blank mold 12 at different times during the forming cycle. Of course, modifying the timing of the flow of cooling fluid may be modified in combination with, or separate from, modifying the duration of cooling fluid flow.

The cooling system 76 may be operated in accordance with any of a variety of control strategies. In one control strategy, at least one of a molten glass gob G, a glass parison P, or a glass container GC is observed either visually or by glass inspection equipment in one or more glass container forming cycles and the flow of cooling fluid to the blank mold 12 is controlled in response. For example, the glass parison P in one or more forming cycles may be observed as elongating asymmetrically under the force of gravity when held by the neck ring 22 prior to the blow mold 14 closing around the parison P. If a portion of the glass parison P is elongating slower than expected, the temperature of the glass within that portion of the parison P may be too low and, conversely, if a portion of the glass parison P is elongating faster than expected, the temperature of the glass within that portion of the parison P may be too high. Any such asymmetric elongation of the parison P may result in glass being too unevenly distributed within the formed glass container GC. As another example, the glass container GC produced in one or more forming cycles may be observed as exhibiting a variable wall thickness about its perimeter that is outside of a predetermined glass wall thickness distribution. The portion of the glass container GC that is too thick may suggest that the corresponding portion of the glass parison P is too cold and vice versa. And in yet another example, the temperature of the molten glass gob G around the perimeter of the gob G in one or more forming cycles may be observed with a thermal imager just before the gob G enters the blank mold 12. This observation may indicate whether a portion of the gob G, and thus a corresponding portion of the glass parison P, is too cold or too hot relative to the rest of the gob G.

Based on the observations of the molten glass gob G, the glass parison P, and/or the glass container GC, an individual enters flow control instructions into the HMI 136 and the process controller 134 receives and executes the flow control instructions. The individual may, for one or more subsequent forming cycles, instruct the process controller 134 to adjust the flow of cooling fluid to any one or more of the sectors I, II, III, IV of the blank mold 12 so that the temperature T_{I}, T_{II}, T_{III}, T_{IV} of at least one of the sectors I, II, III, IV of the blank mold 12 is modified to be different than or equal to the temperature T_{I}, T_{II}, T_{III}, T_{IV} of at least one other sector I, II, III, IV of the blank mold 12. For instance, after a glass parison P is formed in the blank mold 12 and transferred to the blow mold 14 as part of one forming cycle, an inspection of the glass parison P while suspended from the neck ring 22 and prior to closing of the blow mold 14 may reveal that the portion of parison P that contacts the blank mold cavity surface 18 of the blank mold 12 within sectors I and IV is elongating slower under the force of gravity than the portion of the parison P that contacts the blank mold cavity surface 18 of the blank mold 12 within sectors II and III. In response, for at least one subsequent forming cycle, the operator may instruct the process controller 134 to adjust the flow of cooling fluid to at least one of the sectors I, II, III, IV to either increase the temperature T_{I}, T_{IV} of sectors I and IV of the blank mold 12 and/or to decrease the temperature T_{II}, T_{III} of sectors II and III of the blank mold 12 to cause corresponding changes to the temperature (and thus viscosity) of the glass parison P so that elongation of the parison P is more consistent.

In another control strategy, the temperature T_{I}, T_{II}, T_{III}, T_{IV} of each sector I, II, III, IV of the blank mold 12 is measured during one or more forming cycles and the flow of cooling fluid to the blank mold 12 is controlled in response. For example, the thermal imager 138 may obtain a thermal image of the baffle end 26 of the blank mold 12 during a portion of the forming cycle in which the baffle 38 is moved away from the mold 12—e.g., just after the blank mold 12 is closed to receive a molten glass gob G or just before the mold 12 is opened to remove the glass parison P. From the thermal images, the temperatures T_{I}, T_{II}, T_{III}, T_{IV} of the sectors I, II, III, IV of the blank mold 12 may be determined, and an individual may discern that the temperature T_{I}, T_{II}, T_{III}, T_{IV} of one or more of the sectors I, II, III, IV of the blank mold 12 needs to be adjusted in one or more subsequent forming cycles. In that case, the individual may enter temperature change instructions into the HMI 136 and the process controller 134, upon receiving the temperature change instructions, generates flow control instructions. The process controller 134 then executes the flow control instructions to adjust the flow of cooling fluid to any one or more of the sectors I, II, III, IV of the blank mold 12 to modify the temperature T_{I}, T_{II}, T_{III}, T_{IV} of one or more of the sectors I, II, III, IV of the mold 12 accordingly.

In yet another control strategy, the temperature T_{I}, T_{II}, T_{III}, T_{IV} of any one or more of the sectors I, II, III, IV of the blank mold 12 is monitored by the process controller 134 and the flow of cooling fluid to the blank mold 12 is controlled, in response, by the controller 134 as well. For example, an individual may set the temperature set point T_{IS}, T_{IIS}, T_{IIIS}, T_{IVS} for any one or more, and preferably all of, the sectors I, II, III, IV of the blank mold 12 to compensate for temperature fluctuations in the glass gob G or the glass parison P based on previous observations, calculations, experience, or some other insight. Indeed, the temperature set point T_{IS}, T_{IIS}, T_{IIIS}, T_{IVS} of at least one of the sectors I, II, III, IV of the blank mold 12 may be different than or equal to the temperature set point T_{IS}, T_{IIS}, T_{IIIS}, T_{IVS} of at least one other sector I, II, III, IV of the blank mold 12. The temperature T_{I}, T_{II}, T_{III}, T_{IV} of the one or more sectors I, II, III, IV of the blank mold 12 is measured by the thermal imager 138 and/or the temperature sensors 140a, 140b, 140c, 140c and the temperature measurement data is communicated to the process controller 134 as input information.

The process controller 134 receives the temperature measurement data, monitors the temperature T_{I}, T_{II}, T_{III}, T_{IV} of the one or more sectors I, II, III, IV of the blank mold 12 over time, generates flow control instructions if the temperature T_{I}, T_{II}, T_{III}, T_{IV} of the one or more sectors I, II, III, IV of the blank mold 12 deviates from its corresponding temperature set point T_{IS}, T_{IIS}, T_{IIIS}, T_{IVS}, and executes the flow control instructions to adjust the flow of cooling fluid to the one or more of the sectors I, II, III, IV of the blank mold 12 to bring the temperature T_{I}, T_{II}, T_{III}, T_{IV} of the one or more sectors I, II, III, IV of the blank mold 12 back to its respective temperature set point T_{IS}, T_{IIS}, T_{IIIS}, T_{IVS}. If, for instance, the temperature T_{I} of the first sector I of the blank mold 12 as measured by the thermal imager 138 and/or the temperature sensor 140a falls below the designated temperature set point T_{IS}, the process controller 134 will recognize that condition based on a comparison of temperature measurement data (i.e., T_{I}) and the set point T_{IS} and execute the generated flow control instructions to correct the temperature fluctuation. The process controller 134 in this situation may close the first flow control valve 98a to the closed position, and thereby block cooling fluid flow to the first subset of the cooling channels 30I, until the temperature T_{I} of the first sector I is increased to the temperature set point T_{IS}. On the other hand, if the temperature T_{I} of the first sector I of the blank mold 12 rises above the designated temperature set point T_{IS}, the process controller 134 may keep the first flow control valve 98a in the open position and allow cooling fluid to flow to the first subset of the cooling channels 30I until the temperature T_{I} of the first sector I is decreased to the temperature set point T_{IS}.

The several control strategies described may be employed separately or two or more of the strategies may be employed together. For example, it may be the case that a portion of the molten glass gob G received in the blank mold 12 during each glass container forming cycle has a lower temperature than another portion of the glass gob G as a result of the gob G losing heat unevenly as it slides against colder components of a gob distribution system. In each forming cycle, the portion of the glass gob G having a lower temperature may be consistently oriented to contact the same sector or sectors S of the blank mold 12. To compensate for the temperature difference of the molten glass gob G, the process controller 134 may maintain the sector or sectors S of the blank mold 12 against which the colder portion of the gob G makes contact at a temperature above the temperature of the other sector or sectors S of the blank mold 12 consistent with temperature set points established for each sector S. As the forming machine 10 continues to operate, changing conditions throughout the plant including to the furnace or melter, among others, may cause changes to the temperature and/or shape of the molten glass gob G being received in the blank mold 12. Upon observing such changes or its effects on the glass parison P and/or the glass container GC, an individual may override the temperature set points and instruct the process controller 134 to adjust the flow of cooling fluid to one or more sectors S of the blank mold 12 through flow control instructions input directly to the controller 134, or through temperature change instructions input to the controller 134, to correspondingly change the temperature of one or more sectors S of the blank mold 12. All of these controls of the flow of cooling fluid to the blank mold 12 are performed remotely.

As used in herein, the terminology “for example,” “e.g.,” “for instance,” “like,” “such as,” “comprising,” “having,” and “including,” when used with a listing of one or more elements, is to be construed as open-ended, meaning that the listing does not exclude additional elements. Also, as used herein, the term “may” is an expedient merely to indicate optionality, for instance, of a disclosed embodiment, element, or feature. Finally, the subject matter of this application is presently disclosed in conjunction with several explicit illustrative embodiments and modifications to those embodiments, using various terms. All terms used herein are intended to be merely descriptive, rather than necessarily limiting, and are to be interpreted and construed in accordance with their ordinary and customary meaning in the art, unless used in a context that requires a different interpretation. As such, many other embodiments, modifications, and equivalents thereto will readily be suggested to persons of ordinary skill in the art in view of the present disclosure and all such variations, even though not necessarily explicitly disclosed, that fall within the scope of the accompanying claims are intended to be embraced by the present disclosure.

1. A glass forming machine comprising:
a blank mold half of a blank mold, the blank mold half defining at least one axial cooling channel; and
a blank mold hanger having a blank mold hanger half supporting the blank mold half of the blank mold, the blank mold hanger half defining at least one cooling fluid outlet that is in fluidic communication with the at least one axial cooling channel of the blank mold half, the blank mold hanger half further including at least one flow control valve that is remotely controllable and configured to selectively adjust a flow of cooling fluid through the at least one axial cooling channel of the blank mold half.

2. The glass forming machine set forth in claim 1, wherein the blank mold includes a plurality of axial cooling channels, wherein the blank mold hanger half defines a first cooling fluid outlet and a second cooling fluid outlet, and wherein the blank mold hanger half includes a first flow control valve configured to selectively adjust a flow of cooling fluid through the first cooling fluid outlet and a second flow control valve configured to selectively adjust a flow of cooling fluid through the second cooling fluid outlet.

3. The glass forming machine set forth in claim 2, wherein the blank mold hanger half supports the blank mold half such that the first cooling fluid outlet is in fluidic communication with a first subset of the cooling channels and the second cooling fluid outlet is in fluidic communication with a second subset of the cooling channels, and wherein the first flow control valve is configured to selectively adjust the flow of cooling fluid through the first subset of cooling channels and the second flow control valve is configured to selectively adjust the flow of cooling fluid through the second subset of cooling channels.

4. The glass forming machine set forth in claim 3, wherein each of the first subset of cooling channels and the second subset of cooling channels is part of a circular array of the plurality of axial cooling channels of the blank mold, and wherein each of the first cooling fluid outlet and the second cooling fluid outlet is an arcuate slot axially aligned with and circumferentially spanning its respective subset of cooling channels.

5. The glass forming machine set forth in claim 3, wherein the first subset of cooling channels is encompassed by a first angular sector of the blank mold and the second subset of cooling channels is encompassed by a second angular sector of the blank mold, each of the first and second sectors of the blank mold being established in the blank mold half.

6. The glass forming machine set forth in claim 5, wherein each of the first angular sector and the second angular sector is a quadrant of the blank mold.

7. The glass forming machine set forth in claim 1, wherein the flow control valve includes a valve plug that is selectively moveable from a rest position to an actuated position to adjust the flow of cooling fluid through the cooling fluid outlet.

8. The glass forming machine set forth in claim 7, wherein the blank mold hanger half includes a valve seat and the valve plug of the flow control valve moves axially with respect to the valve seat between the rest position and the actuated position.

9. The glass forming machine set forth in claim 8, wherein the rest position is an open position of the flow control valve, in which the valve plug is spaced apart from the valve seat, and the actuated position is a closed position of the flow control valve, in which the valve plug is seated against the valve seat.

10. The glass forming machine set forth in claim 9, wherein the flow control valve is biased to the rest position and is pneumatically actuatable from the rest position to the actuated position.

11. The glass forming machine set forth in claim 8, wherein a guide wall extends axially away from the valve seat and the valve plug of the flow control valve contacts and slides against the guide wall.

12. The glass forming machine set forth in claim 1, wherein the blank mold hanger further comprises a second blank mold hanger half configured to support a second blank mold half of the blank mold, the blank mold hanger half and the second blank mold hanger half being configured to move their respective blank mold halves between an open position of the blank mold and a closed position of the blank mold, the second blank mold half defining at least one axial cooling channel and the second blank mold hanger half defining at least one cooling fluid outlet that is in fluidic communication with the at least one axial cooling channel of the second blank mold half, the second blank mold hanger half further including at least one flow control valve configured to selectively adjust a flow of cooling fluid through the at least one axial cooling channel of the second blank mold half.

13. The glass forming machine set forth in claim 12, wherein the blank mold hanger half defines a first cooling fluid outlet and a second cooling fluid outlet and the second blank mold hanger half defines a third cooling fluid outlet and a fourth cooling fluid outlet, the blank mold hanger half including a first flow control valve configured to selectively adjust a flow of cooling fluid through the first cooling fluid outlet and a second flow control valve configured to selectively adjust a flow of cooling fluid through the second cooling fluid outlet, and the second blank mold hanger half including a third flow control valve configured to selectively adjust a flow of cooling fluid through the third cooling fluid outlet and a fourth flow control valve configured to selectively adjust a flow of cooling fluid through the fourth cooling fluid outlet.

14. The glass forming machine set forth in claim 13, wherein the blank mold hanger half and the second blank mold hanger half support the blank mold half and the second blank mold half, respectively, such that the first cooling fluid outlet is in fluidic communication with a first subset of the cooling channels, the second cooling fluid outlet is in fluidic communication with a second subset of the cooling channels, the third cooling fluid outlet is in fluidic communication with a third subset of cooling channels, and the fourth cooling fluid outlet is in fluidic communication with a fourth subset of the cooling channels.

15. The glass forming machine set forth in claim 1, wherein the blank mold hanger half further comprises a plenum that defines a main interior chamber configured to receive an input flow of cooling fluid, the plenum further defining a cooling flow passage and a passage opening, the cooling flow passage extending from the passage opening, which connects the cooling flow passage with the main interior chamber, to the cooling fluid outlet.

16. The glass forming machine set forth in claim 15, wherein the plenum further defines one or more cooling fluid holes separate from the cooling fluid outlet.

17. The glass forming machine set forth in claim 15, wherein the at least one flow control valve moves within the plenum with respect to the passage opening to selectively adjust the flow of cooling fluid through the passage opening and into the cooling flow passage.

18. A glass forming machine comprising:
a blank mold that defines a plurality of axial cooling channels and includes a first blank mold half and a second blank mold half; and
a blank mold hanger that includes a first blank mold hanger half and a second blank mold hanger half, the first blank mold half being carried by the first blank mold hanger half and the second blank mold half being carried by the second blank mold hanger half, wherein the first blank mold hanger half further defines a first cooling fluid outlet and a second cooling fluid outlet, the first cooling fluid outlet being in fluidic communication with a first subset of the cooling channels defined in the first blank mold half within a first sector of the blank mold, and the second cooling fluid outlet being in fluidic communication with a second subset of the cooling channels defined in the first blank mold half within a second sector of the blank mold, the first blank mold hanger half further including:
a plenum defining a main interior chamber configured to receive an input flow of cooling fluid, the plenum further defining a first cooling flow passage extending from the first cooling fluid outlet to a first passage opening connected to the main interior chamber and a second cooling flow passage extending from the second cooling fluid outlet to a second passage opening connected to the main interior chamber;
a first flow control valve that is remotely controllable and configured to selectively adjust a flow of cooling fluid out of the first cooling fluid outlet and through the first subset of cooling channels; and
a second flow control valve that is remotely controllable and configured to selectively adjust a flow of cooling fluid out of the second cooling fluid outlet and through the second subset of cooling channels.

19. The glass forming machine set forth in claim 18, wherein each of the first flow control valve and the second flow control valve includes a valve plug that is selectively axially moveable relative to a valve seat, which circumscribes the respective first or second passage opening, from a rest position in which the valve plug is spaced apart from the valve seat to an actuated position in which the valve plug is seated against the valve seat.

20. The glass forming machine set forth in claim 19, wherein the valve plug of the first flow control valve and the second flow control valve is biased to the rest position.

21. The glass forming machine set forth in claim 18, wherein the second blank mold hanger half further defines a third cooling fluid outlet and a fourth cooling fluid outlet, the third cooling fluid outlet being in fluidic communication with a third subset of the cooling channels defined in the second blank mold half within a third sector of the blank mold, and the fourth cooling fluid outlet being in fluidic communication with a fourth subset of the cooling channels defined in the second blank mold half within a fourth sector of the blank mold, the second blank mold hanger half further including:
a plenum defining a main interior chamber configured to receive an input flow of cooling fluid, the plenum further defining a third cooling flow passage extending from the third cooling fluid outlet to a third passage opening connected to the main interior chamber of the second blank mold hanger half and a fourth cooling flow passage extending from the fourth cooling fluid outlet to a fourth passage opening connected to the main interior chamber of the second blank mold hanger half;
a third flow control valve that is remotely controllable and configured to selectively adjust a flow of cooling fluid out of the third cooling fluid outlet and through the third subset of cooling channels; and
a fourth flow control valve that is remotely controllable and configured to selectively adjust a flow of cooling fluid out of the fourth cooling fluid outlet and through the fourth subset of cooling channels.

22. A method of cooling a blank mold, the method comprising:
providing a forming machine that includes a blank mold, the blank mold defining a plurality of axial cooling channels and having a first blank mold half and a second blank mold half, the first blank mold half being carried by a first blank mold hanger half and the second blank mold half being carried by a second blank mold hanger half, and wherein each of the first blank mold half and the second blank mold half contains one or more sectors of the blank mold with each sector of the blank mold encompassing a subset of the plurality of cooling channels;
supplying a flow of cooling fluid to the subset of the plurality of cooling channels in each sector of the first blank mold half and each sector of the second blank mold half through a plenum of the first blank mold hanger half and a plenum of the second blank mold hanger half, respectively, wherein the flow of cooling fluid to the subset of the plurality of axial cooling channels in each sector of the first blank mold half and each sector of the second blank mold half is separately controlled by a flow control valve associated with each sector; and
selectively actuating one or more of the flow control valves to adjust the flow of cooling fluid to at least one sector of the blank mold relative to at least one other sector of the blank mold.

23. The method set forth in claim 22, wherein selectively actuating the one or more flow control valves modifies a temperature of at least one of the sectors of the blank mold to be different than a temperature of at least one other sector of the blank mold.

24. The method set forth in claim 22, further comprising:
receiving input information at a system controller indicating an adjustment to the flow of cooling fluid to one or more of the sectors of the blank mold;
obtaining flow control instructions from the input information that indicate how to selectively actuate one or more of the flow control valves; and
executing the flow control instructions to selectively actuate one or more of the flow control valves to adjust the flow of cooling fluid to at least one sector of the blank mold relative to at least one other sector of the blank mold, wherein the controller executes the flow control instructions.

25. The method set forth in claim 24, wherein the input information is received from a human-machine interface and includes the flow control instructions.

26. The method set forth in claim 24, wherein the input information is received from a human-machine interface and includes temperature change instructions indicating how a temperature of at least one of the sectors of the blank mold is to be modified to be different than or equal to the temperature of at least one other sector of the blank mold, and wherein obtaining the flow control instructions includes converting the temperature change instructions into the flow control instructions.

27. The method set forth in claim 24, wherein the input information includes temperature measurement data, and wherein obtaining the flow control instructions includes converting the temperature measurement data into the flow control instructions.

28. The method set forth in claim 24, further comprising:
setting a temperature set point for one or more of the sectors of the blank mold;
monitoring the temperature of the one or more sectors of the blank mold to attain temperature measurement data;
generating the flow control instructions based on the temperature measurement data; and
adjusting the flow of cooling fluid to one or more of the sectors of the blank mold as specified by the flow control instructions to maintain a temperature of the one or more sectors of the blank mold at the corresponding temperature set point.

29. The method set forth in claim 24, wherein selectively actuating the one or more flow control valves modifies a duration during which cooling fluid flows to one or more of the sectors of the blank mold.

30. The method set forth in claim 24, wherein selectively actuating the one or more flow control valves modifies a time during a forming cycle of the glass forming machine at which the flow of cooling fluid to one or more of the sectors of the blank mold starts or stops.

31. The method set forth in claim 24, wherein the flow control instructions are based on observations of at least one of a molten glass gob received in the blank mold, a glass parison formed in the blank mold, or a glass container formed from a glass parison formed in the blank mold.

32. A method of cooling a blank mold, the method comprising:
directing a flow of cooling fluid through a plurality of axial cooling channels defined in a blank mold; and
adjusting the flow of cooling fluid through a subset of cooling channels in at least one of a plurality of angular sectors of the blank mold to modify a temperature of at least one angular sector of the blank mold to be different than a temperature of at least one other angular sector of the blank mold.

33. The method set forth in claim 32, wherein the flow of cooling fluid through the subset of cooling channels in each of the plurality of angular sectors of the blank mold is controlled by a flow control valve, and wherein adjusting the flow of cooling fluid comprises selectively and remotely actuating one or more of the flow control valves.

34. The method set forth in claim 32, wherein adjusting the flow of cooling fluid is performed by a system controller and comprises executing flow control instructions obtained from input information received by the system controller from at least one of a human-machine interface, a thermal imager, a temperature sensor, or glass inspection equipment.
